(19) United States
(12) Patent Application Publication
(10) Pub. No.: US 2010/0044463 A1
(43) Pub. Date: Feb. 25, 2010

(54) PLANT IRRIGATION, OXYGENATION AND FEEDING DEVICE

(75) Inventors: Frank J. Walker, Troy, MI (US); Jeffrey K. Thomas, Commerce Township, MI (US)

Correspondence Address: GIFFORD, KRASS, SPRINKLE,ANDERSON & CITKOWSKI, P.C, PO BOX 7021, TROY, MI, 48007-7021, US

(73) Assignee: Morgan Concepts, Inc., Union Lake, MI (US)

(21) Appl. No.: 12/540,590

(22) Filed: Aug. 13, 2009

Related U.S. Application Data
(60) Provisional application No. 61/088,536, filed on Aug. 13, 2008.

(51) Int. Cl. B05B 15/06

(52) U.S. Cl. 239/201

(57) ABSTRACT

A plant irrigation, oxygenation, and feeding device includes an elongated tubular frame having a sidewall and a cap positioned on each end. The sidewall includes a plurality of apertures dimensioned to substantially prevent ground water exterior to the tubular body from entering an interior of the body while permitting the passage of air and water from the interior of the tubular frame to the exterior of the tubular frame.

### RELATED APPLICATION

This application claims priority of U.S. Provisional Patent Application Ser. No. 61/088,536 filed Aug. 13, 2008, which is incorporated herein by reference.

### FIELD OF THE INVENTION

The invention relates to a plant irrigation, oxygenation, and feeding device.

### BACKGROUND OF THE INVENTION

Plants including a tree, bush, or shrub, need to receive water and additional nutrients in order to grow satisfactorily. Plants must typically receive water and oxygen from above ground level down to their roots where it is needed, Various prior art sprinkler and irrigation devices may apply water to a planting area. However there is a need in the art for an improved device that provides water, oxygen and other nutrients to desired levels within the soil to promote growth of a plant.

### SUMMARY OF THE INVENTION

In one aspect there is disclosed a plant irrigation, oxygenation, and feeding device that includes an elongated tubular frame having a sidewall and a cap positioned on each end. The sidewall includes a plurality of apertures dimensioned to increase the surface area of the side wall while permitting the passage of air and water from the interior of the tubular frame to the exterior of the tubular frame. At least one delivery device is positioned within the tubular frame. The delivery device uniformly directs water to the sidewall.

In another aspect there is disclosed a plant irrigation, oxygenation, and feeding device that includes an elongated tubular frame having a sidewall and a cap positioned on each end, the sidewall including a plurality of apertures dimensioned to increase the surface area of the side wall while permitting the passage of air and water from the interior of the tubular frame to the exterior of the tubular frame. At least one delivery device is positioned within the tubular frame the delivery device directing water to the sidewall. The delivery device includes a series of openings formed therein allowing water to pass through the delivery device and convective air currents to travel within the tubular frame.

In a further aspect there is disclosed a plant irrigation, oxygenation, and feeding device that includes an elongated tubular frame having a sidewall and a cap positioned on each end, the sidewall including a plurality of apertures dimensioned to increase the surface area of the side wall while permitting the passage of air and water from the interior of the tubular frame to the exterior of the tubular frame. At least one delivery device is positioned within the tubular frame the delivery device directing water to the sidewall. The delivery device includes a body formed of flexible material having a peripheral edge that engages the side wall of the tubular body when the delivery device is positioned in the tubular frame. The delivery device includes slotted openings formed in the body that extend from the edge toward the center of the body. The slotted openings compress when the delivery device is positioned in the tubular frame such that the body moves forming a frustum or domed shaped delivery device that delivers water evenly down the side wall of the tubular frame wherein the water interlaces with the plurality of apertures delivering water gently to a surrounding soil and oxygenating the water.

The delivery device may include a flexible disk or spiral that is designed to conform to a surrounding and supporting tubular frame. The device may function to uniformly disperse in a circular manner water that falls upon it. In doing so, the water is directed to its outer border, which interfaces with the tubular frame, and allows the water to fall down the wall of the tubular frame while interacting with a porous wall surface. The tubular frame may have many openings of varying small dimensions in its sidewall from the top to the base at the bottom and all around its surface which allows the water to travel or cascade in a downward manner. The extensive water to tubular surface ratio allows the water to be more accessible to the plant's root base that it serves. The controlled falling of the water assists in oxygenating the water for the plant and also creates a change in temperature thereby enhancing air convection currents within the tubular frame. This convection of air current causes change to the fresh air/stale air ratio to better serve the plant. Lastly, nutrients may be introduced to a greater range of root mass that provides additional benefit to the plant being served.

### BRIEF DESCRIPTION OF THE DRAWINGS

The various advantages of the device will become apparent to those skilled in the art after reading the following specification and reference to the drawings in which:

FIG. 1 is a top side view of a distribution device for water, air and nutrients;

FIG. 2 is a side view of the distribution device shown in an uninstalled state;

FIG. 3 is a side view of the distribution device in an installed state;

FIG. 4 is a side view of irrigation components;

FIG. 5. is a top view of the distribution device as it would be viewed when installed in the tubular frame with the irrigation components;

FIG. 6 is a side view of a finishing top grate of the subterranean irrigation, collection, distribution, system;

FIG. 7 is a sectional view of a top mounting cap that is used to couple the top grate cap, the tubular porous wall frame and irrigation components;

FIG. 8 is an exploded view of the assembly including the distribution device, irrigation components, top mounting cap, finishing top grate, and tubular frame;

FIG. 9 is a side view of the assembled components of FIG. 8;

FIG. 10 is a cut away side view of the assembled device including direct feed lines;

FIG. 11 is a cut away side wall view of the assembled device including a variable center core dimension to accept varied diameter devices;

FIG. 12 is a diagram including a soil depth and root position illustrating the uniform horizontal and radial pathway of water, air, and nutrients distribution;

FIG. 13 is a partial view detailing the tubular frame, distribution device, top water cap and water to the feeder roots of plants without the use of jetted water;

FIG. 14 is an environmental view of the assembly;

FIG. 15 is a top view of an alternative embodiment of a distribution device;

FIG. 16 is a side view of the alternative distribution device of FIG. 15;

FIG. 17 is a side view of the alternative embodiment of the FIG. 15 installed within the tubular frame;

FIG. 18 is a perspective view of another alternative embodiment of a distribution device;

FIG. 19 are partial sections of the alternative embodiment of FIG. 18;

FIG. 20 is a partial side view of the alternative embodiment of FIG. 18 installed within the tubular frame.

### DETAILED DESCRIPTION

It can be desirable that plants receive an appropriate amount of water, air, and nutrients such as fertilizer and phosphates, especially during the first several years after planting, for facilitating the maturity of their root structures. Accordingly, the device disclosed herein is directed to providing a subterranean plant root water and air collection and delivery device that may efficiently collect and redirects air, natural flowing surface water, subterranean water, manually supplied water, and/or water and nutrients supplied by an irrigation system to the roots of trees, shrubs, and bushes or plants to improve the growth and the health of such plants.

The device may be integrated into an underground irrigation system and/or may be used as a completed stand-alone system where underground irrigation is not available.

Additionally, the present device may efficiently and effectively deliver irrigation water, air, nutrients, and/or manual above ground application of air, water and/or fertilizers and efficiently delivers these substances to the root structures of all types of plants.

This device not limited to any particular shape or dimensions of any tubular like device for which it is installed. Additionally, this device is designed to improve the effectiveness of the delivery of water, air and nutrients of any subterranean delivery device that is tubular in design. Additionally, the design of this device may allow for service and replacement if needed. The device is designed to minimize the time, effort, and any tools that may be required for upgrades or service.

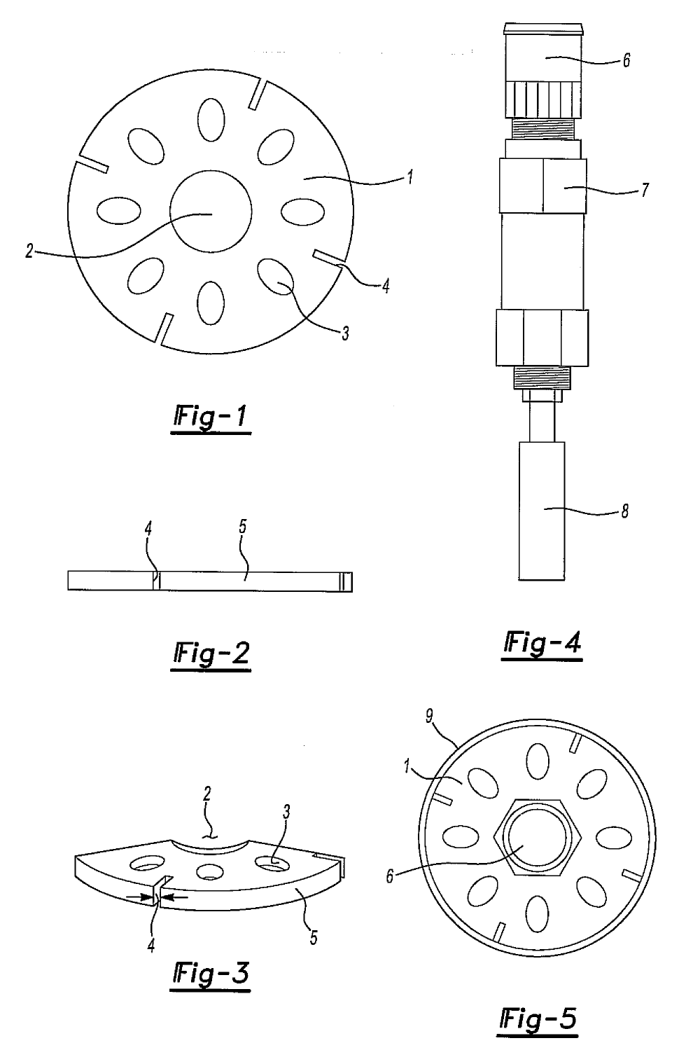

Referring to FIG. 1, there is shown one embodiment of a delivery device 1 in the form of a circular disc that may divert water, air, and nutrients to its outer edge or mid-point orifices as the water, air, and nutrients are delivered to its surface from a distance above the wide surface area of the delivery device. The delivery device 1 may be manufactured of materials including plastics, foams, organic pressed materials, metals or any other material that provides performance, durability, flexibility, economic worth, quality in manufacturing, abundance, resistance to certain substances, serviceability, and will withstand temperature extremes.

Referring now to FIGS. 1, 3, 4 and 8, the delivery device 1 has a near or center opening 2 that may be of any shape that allows the delivery device 1 to function along with adjoining mounting hardware and/or irrigation components such as is shown in FIG. 4 and FIG. 8. Additionally, as shown in FIG. 1, the delivery device 1 may have edge slotted openings 4 that may compress to a closed or near closed state when the device 1 is inserted into a tubular frame 9. The side wards compression of the slotted openings as shown in FIG. 3 draws the disc center upwards at an angle that is above, or below the center opening 2 forming a frustum or dome. The sidewall 5 of the delivery device 1 has a positive pressure induced onto it from the physical energy that is generated from the delivery device 1 is being placed in to a tubular frame 9 that is of a lesser inside diameter than the outside diameter of the delivery device 1. This sustained outward pressure from the now frustum shaped disc allows the disc outer surface 5 to contact the uneven inner surface of the tubular frame member 9 allowing water passage. The material of the delivery device 1 is selected as to allow self adjusting to varied dimensional surfaces of the tubular frame 9. In one aspect, the delivery device 1 remains stationary at a selected location along the lateral length of the tubular frame 9.

The center opening 2 allows adequate movements of the construction material of device 1 to form the frustum without the delivery device 1 distorting its shape. The delivery device 1 also allows a mounting device or irrigation components 6, 7, and 8 as represented in FIG. 4 to pass through the center opening 2 to allow the water, air and nutrients to flow from the top of the irrigation components onto the delivery device 1. The center opening 2 allows a pathway for water to pass downwards past if the delivery device 1 is not pressure fit onto irrigation components. The center opening 2 may also allow air to pass through any open space to aid in convection of the warm and cool air within the tubular frame 9. The inside diameter of the center opening member 2 will be constructed to be less that the outer diameter of a mounting device (not shown) or the irrigation components 6, 7 and 8 of FIG. 4 and as shown assembled in FIG. 5 and FIG. 9 and FIG. 10 and FIG. 11.

The delivery device 1 may include a series of openings 3 that may be of any shape, any dimension, and any quantity as the application deems necessary. In the depicted embodiment eight openings 3 are shown. The openings 3 allow a portion of the falling water, air, nutrients from above, either manually, naturally, or by pressure to flow and pass through the delivery device 1. The openings 3 function as a regulator to meter the volume of water that is permitted to reach the sidewall and travel down the side wall of the tubular frame 9. The water that flows through the openings 3 may be collected within the tubular frame 9 in the base reservoir of the tube for the plants deeper roots to benefit and to provide a long-term moisture source for the entire root mass.

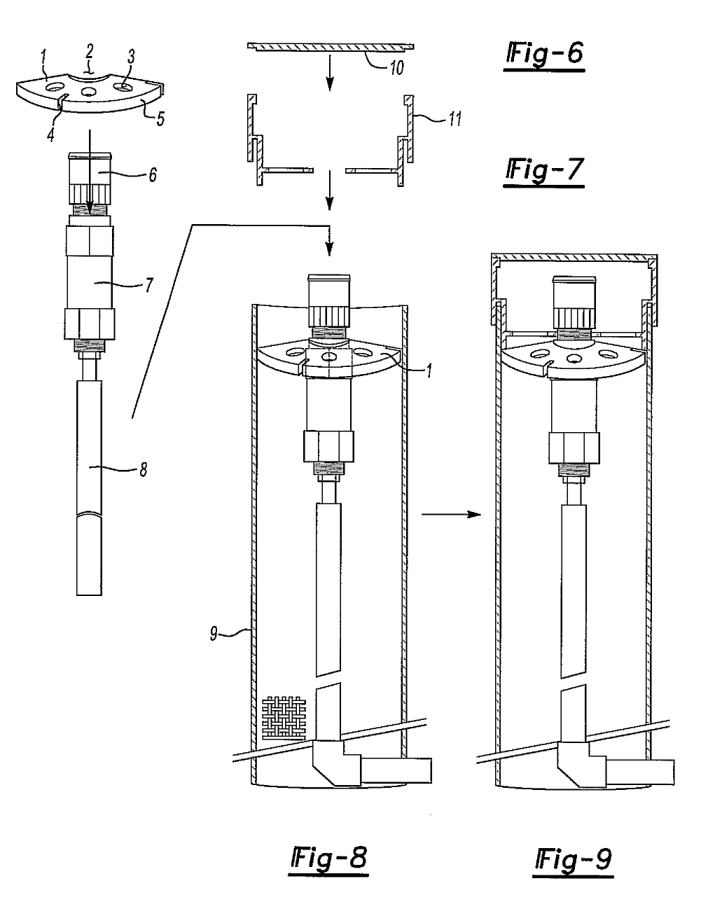

Referring to FIGS. 6 and 7 there is a top cap 11 that may be fitted on the tubular frame 9 and a top grate 10 that may be received in the top cap 11.

Referring to FIG. 8 there is shown an exploded view showing the delivery device 1, tubular frame 9, irrigation components 6, 7 and 8, the top cap 11 and the top grate 10. Assembly of the irrigation components 6, 7, and 8 may be made prior to positioning about the delivery device 1 that may be then fit in and onto the tubular frame member 9. When the delivery device 1 is positioned within the tubular frame 9 the top cap 11 may be inserted on to the tubular frame 9. Thereafter, the top gate 10 of FIG. 6 may be inserted into the top cap 11, as shown in FIG. 9.

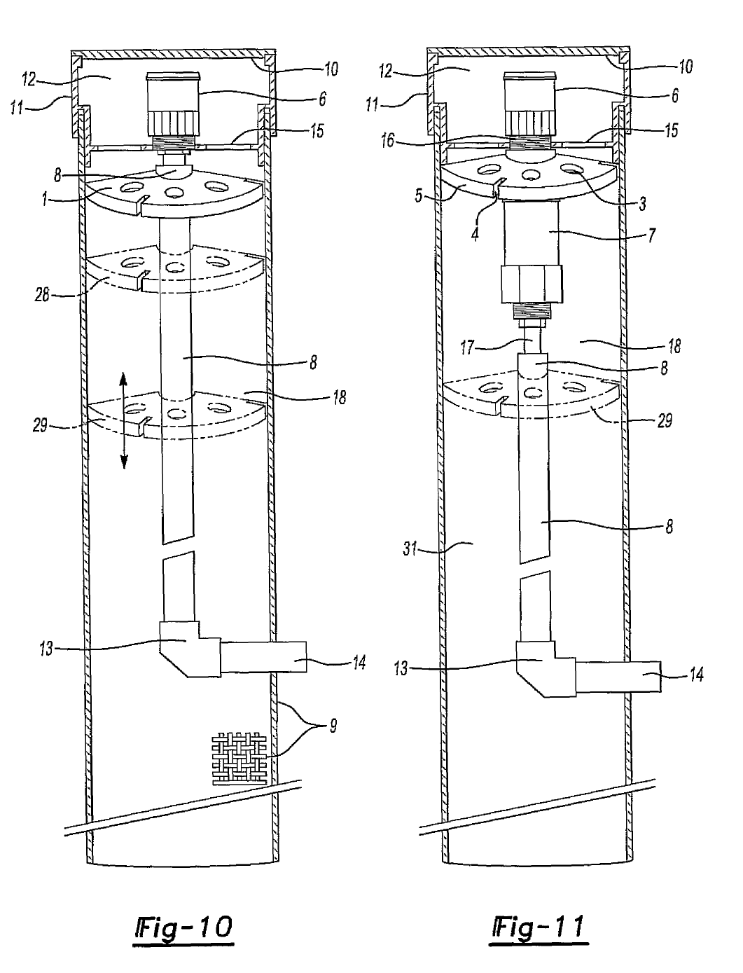

Referring now to FIGS. 10 and 11, the assembled device is shown in a static state with variations to accommodate differing applications. The delivery device 1 is shown in its assembled static position. There may be situations that require additional sidewall water flushing and is depicted in FIG. 10. In FIG. 10 additional delivery devices 1 may be added in plurality as illustrated by delivery devices 28 and 29.

FIGS. 10 and 11 also illustrate the variations in the irrigation water supply components. Looking at FIG. 10, bubbler member 6 is connected directly to a water feed line without regulation or related device member 7 in FIG. 11. In this application, the center opening 2 will be reduced in size to effectively function with the reduced diameter of the water feed pipe/line member 8. It is also illustrated in FIG. 10 that the addition of multiple disc device member 28 and member 29 creates a multi-chamber environment within the tubular frame 9. In doing so, the tubular frame 9 now has multiple actions of internal convection occurring non-stop in all weather. In one aspect, the delivery device 1 makes full continuous 360° contact with the entire sidewall of the tubular frame 9 regardless of the frame's shape. This tight and continuous bond between the delivery device 1 and the side wall of the tubular frame 9 allows uniform water distribution and chambering.

FIG. 11 shows the increased size of the regulator type device member 7 to which the delivery device 1 may be secured. It should be realized that various irrigation components other than those illustrated may be used with similar results.

In one aspect, the irrigation components 6, 7, 8, 13, 14 and 17 are secured and are centered in the top mounting cap 11 at the highest location to maximize the water to tubular surface ratio. The centering of the irrigation components allows water to fall equally on to the delivery device 1 for equal distribution to the outside edge 5.

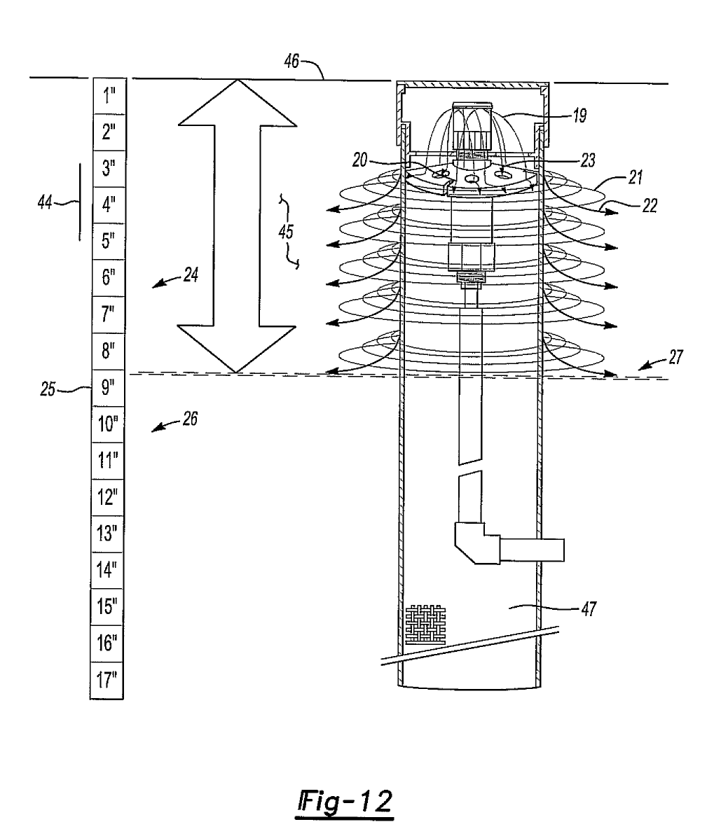

Referring to FIGS. 12, 13, 14 the water denoted by numbers 35, 34, 19, 20 initiates contact with the tubular wall 9 at the point where the tubular frame member 9 joins the top mounting cap 10. FIGS. 10 and FIG. 11 illustrate the top cap member 10 that includes a plurality of openings within it to allow water, air, and nutrients to pass.

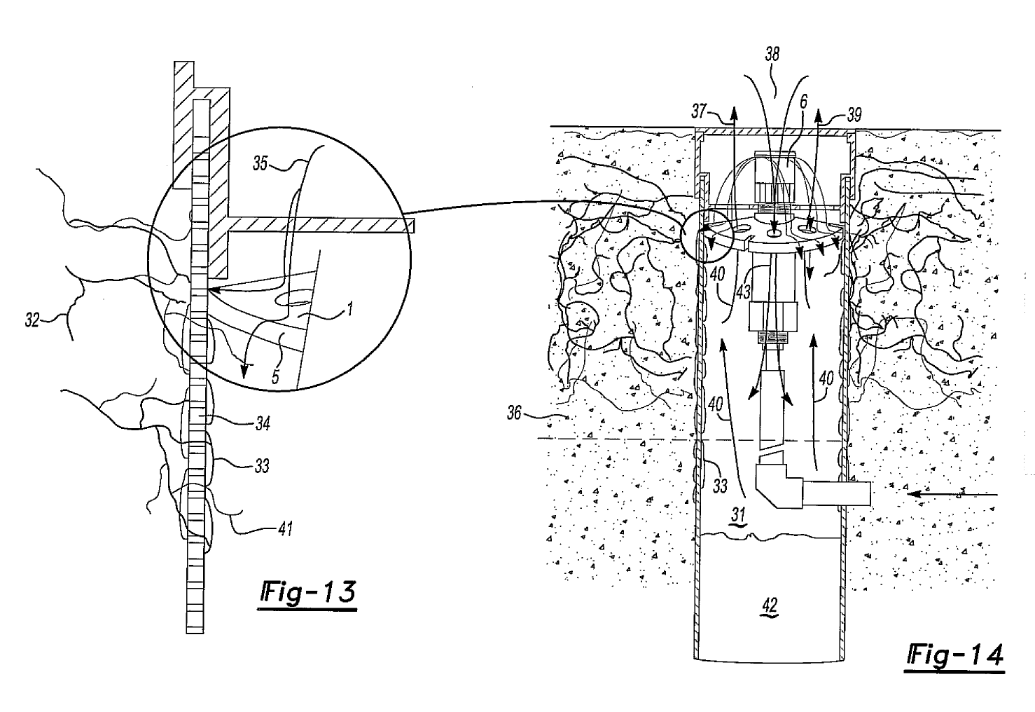

Referring now to FIGS. 13 and 14, the falling water 35 falls on to the delivery device 1 where it flows to the disc device l edge 5 in contact to the tubular frame 9. The pressure of the falling water 35 coupled with the directional pitch of the delivery device 1 which is advantaged to the outer edge 5 meets the porous surface 33 of the tubular frame 9. It is at this point the directional energy of the falling water 35 is redirected downward to weave throughout the porous surface member 33 having apertures 34. This falling water weaving process exposes the water to a tremendous increase in walled surface area that is much greater that the base measurement of a cylinder surface. This process causes the water to oxygenate as it gently baths the feeder roots 32, 41 that have intentionally or unintentionally target and grown into the tubular frame 9 for the moist rich life giving oxygenated environment. This environment that includes an open air chamber 31 and the convection of air indicated by the flow of components 40, 37, 39, 38, 31, 43 via the induced convection current as a result of fill wall contact of the delivery device 1 and the outer edge 5 with the tubular frame 9 provides an ideal root generating and sustaining environment. In one aspect the device provides a non-violent bathing of the feeder roots 32, 41 to naturally invite plant growth and root development. The water that is not absorbed by the plant is captured at the bottom 42 of the tubular frame 9. This stored water may flow into the surrounding soils 36.

Referring now to FIG. 12, the depth chart 44 is detailed in increments of 1 inch with the top of the depth chart 44 beginning at ground surface 46. The depth area as noted by the increment inch measurement numbers 1 to 8 represent to personnel who are knowledgeable in the horticultural sciences the area of depth in most all earthen soils where the majority, a minimum of 80% and as high as 99%, of plant feeder roots reside. The section between one and eight inches is denoted as 45 and the eight inch depth is denoted as 27. Any initial introduction of water, air, and nutrients below this 8″ depth member 27 may not provide the benefit to the plant's health that is desirable. The deep depth member 47 at the bottom of the tube frame 9 may store water, and nutrients, and to provide a large cubic area of oxygen rich air for the purpose of active convection.

Referring to FIGS. 12, 13 and 14 there in shown the outflow of the sidewall falling water 35 as it has traversed from the tubular frame's porous wall 33 including apertures 34 and has flowed within the soil strata 21, 22 to the surrounding area member 24. The violent jetting of water from prior art baffle type systems will erode the adjacent soils and cause the tubular frame to be completely disconnected from the ambient soils and feeder roots. Such jetting and disconnection is prevented by the current inventive device.

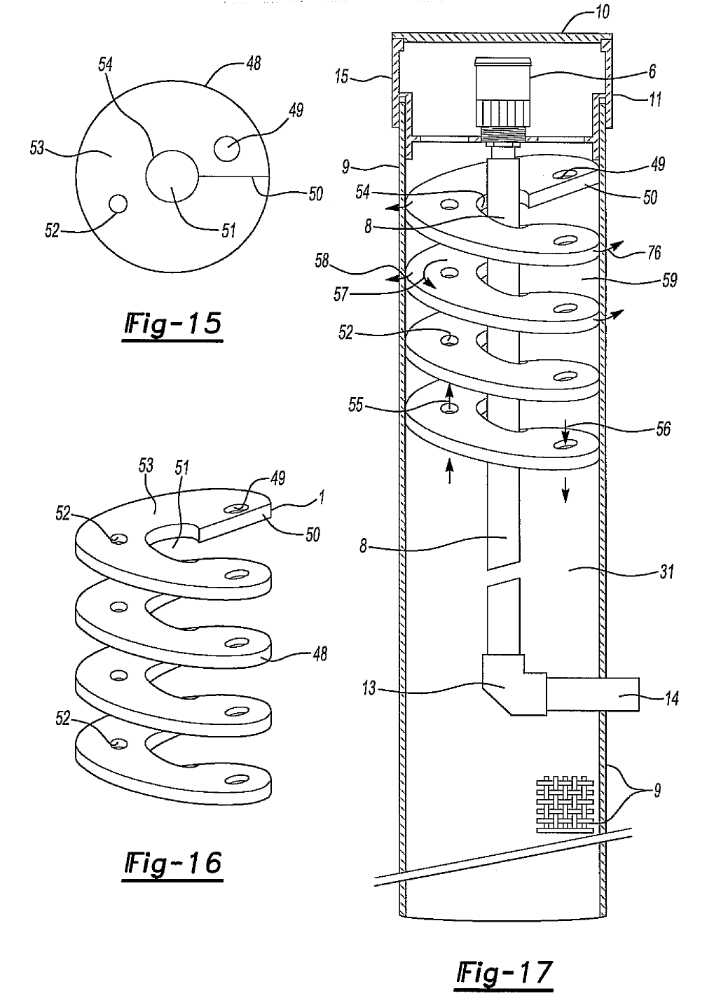

Referring to FIG. 15, there is shown a top view of an alternative embodiment of the delivery device 1. This alternative delivery device 53 includes a spiral shape. The spiral shape of the delivery device 53 may provide additional and uniform wall contact on its continuous outer edge 48. The spacing of each revolution layer may be varied. The delivery device 53 may be easily installed and allows for a higher volume of water to flow yet provide structure to eliminate sidewall erosion. In the depicted embodiment, the delivery device 53 has two orifices 62 and 49 each offset by 180°. The dimension, quantity, and positioning of these orifices may vary greatly. For example, orifices 62 and 49 may not be used. The outer edge 48 of the delivery device 53 is resistive on contact with the tubular frame 9. This resistance works in accordance with the greater diameter of the delivery device 53 than that of the inner tubular frame diameter. As shown, the delivery device 53 may be in a constant state of exerting outward pressure on the inner sidewall of the tubular frame 9. This pressure holds the delivery device 53 in a stationary location within the tubular frame 9. Installation of the delivery member 53 may be achieved by inserting it in to the tubular frame 9 and twisting counter to the spiral winding direction. This compresses the delivery device 53 thus reducing its outer wall diameter allowing it to easily slide into the tubular frame 9. A turn of the delivery device member 53 in the direction of the spiral winding will then seat it in place within the tubular frame 9.

Still referring to FIG. 15, the number 50 identifies the starting top edge of the delivery device 53. Number 48 identifies the outer edge or the outside diameter of the delivery device 53. Item 51 is the center void where the irrigation devices (see FIG. 4) may pass through. The open air space between the inner spiral boundary 54 and the assembly shown in FIG. 4 allow additional air convention as well as water drop area to the lower tubular frame sector member 42.

FIG. 16 details one embodiment of a four-layer spiral for delivery device 53. It should be realized that spirals having various numbers of layers may be utilized. Additionally, the delivery device 53 may be stacked in multiples of two or more.

Referring now to FIG. 17, the delivery device 53 may nest at the highest location relative to the top cap 10. The uniform radial dispersion of water, air, nutrients initiates immediately at the top orifice line in the tubular frame wall member 9. The orifices 62 and 49 are shown in a linear stacked position but may be positioned in differing arrangements. In one aspect, the water flow downward indicated at 57 and the convective air flow indicated at 56 and 55 are produced. The downward water flow is engineered in such a manner as to provide a slow slope that centrifugally guides the water that is oxygenated to the outer edge 48 of the delivery device 53 to the tubular frame 9 where the water gently flows out and on to the tubular frame wall member 9 downward and baths the plant's feeder roots without causing any surrounding collateral damage such as soil erosion and soil collapse. Within and in between each spiral layer may be a continuum air space that benefits from the extensive surface area of the delivery device 63. As the air change due to convection occurs, the air is changed at an increased rate due to the temperature delta between the levels within the open chamber of the tubular frame 9.

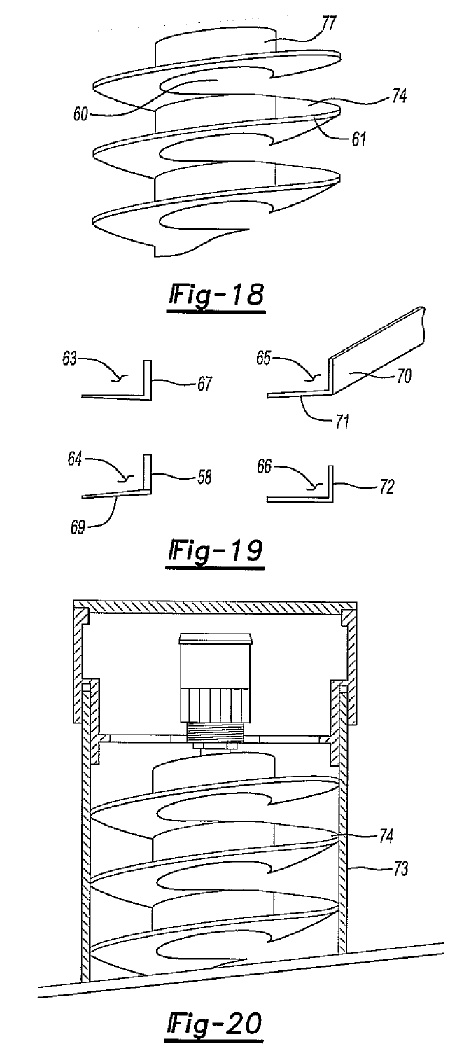

FIG. 18 shows an alternative embodiment of the delivery device 53 that includes an inner vertical surface 77. The inner vertical surface 77 provides a height regulator where the top of the inner vertical surface 77 come in contact with the bottom of the elevated layer 74 from above. This contact produces a vertical column 60 that enhances air convection. As with the previously described embodiments an outer edge 61 may secure the spiral device in place.

FIG. 19 shows various examples of inner vertical surfaces 77 numbered as 67, 68, 70, 72 to produce differing functional effects on the delivery device 53. FIG. 19 also shows various examples of bottom plane surfaces 63, 64, 65, 66 to produce differing functional results.

Referring to FIG. 20 the spiral device 53 with the inner vertical surfaces is shown assembled with the irrigation assembly of FIG. 4. As can be seen in the figure, the outer edge 61 of the delivery device is in contact with the tubular frame 9.

Having thus described certain embodiments of the invention, various other embodiments may become apparent to those of skill in the art that do not depart from the overall scope of the invention.

1. A plant irrigation, oxygenation, and feeding device comprising:
an elongated tubular frame having a sidewall and a cap positioned on each end, the sidewall including a plurality of apertures dimensioned to increase the surface area of the side wall while permitting the passage of air and water from the interior of the tubular frame to the exterior of the tubular frame; and
at least one delivery device positioned within the tubular frame, the delivery device uniformly directing water to the sidewall.

2. The plant irrigation, oxygenation, and feeding device for plant roots of claim 1 wherein the at least one delivery device has a diameter greater than an inner diameter of the tubular frame.

3. The plant irrigation, oxygenation, and feeding device for plant roots of claim 2 wherein the delivery device includes a body formed of flexible material, the body including a peripheral edge that engages the side wall of the tubular body when the delivery device is positioned in the tubular frame.

4. The plant irrigation, oxygenation, and feeding device for plant roots of claim 3 including slotted openings formed in the body, the slotted openings extending from the edge toward the center of the body.

5. The plant irrigation, oxygenation, and feeding device for plant roots of claim 3 wherein the delivery device includes a central opening formed therein.

6. The plant irrigation, oxygenation, and feeding device for plant roots of claim 4 wherein the slotted openings compress when the delivery device is positioned in the tubular frame such that the body moves forming a frustum or domed shaped delivery device that delivers water evenly down the side wall of the tubular frame wherein the water interlaces with the plurality of apertures delivering water gently to a surrounding soil and oxygenating the water.

7. The plant irrigation, oxygenation, and feeding device for plant roots of claim 6 wherein the frustum shaped delivery device exerts an outward pressure wherein the edge of the delivery device is secured to the sidewall including the plurality of apertures.

8. The plant irrigation, oxygenation, and feeding device for plant roots of claim 3 wherein the body includes a series of openings formed therein allowing water to pass through the delivery device and convective air currents to travel within the tubular frame.

9. The plant irrigation, oxygenation, and feeding device for plant roots of claim 1 including a plurality of delivery devices having a diameter greater than the tubular frame, the delivery devices spaced longitudinally from each other and positioned within the tubular frame directing water to the side wall of the tubular frame, the delivery devices defining a plurality of chambers within the tubular frame.

10. The plant irrigation, oxygenation, and feeding device for plant roots of claim 9 wherein the chambers allow air to be concentrated at different temperatures causing air convection currents distributing oxygen to the plurality of apertures.

11. The plant irrigation, oxygenation, and feeding device for plant roots of claim 5 including irrigation components positioned within the tubular frame and extending longitudinally within the tubular frame and passing through the central opening above the delivery device.

12. The plant irrigation, oxygenation, and feeding device for plant roots of claim 1 including a top grate positioned in one of the caps.

13. The plant irrigation, oxygenation, and feeding device for plant roots of claim 2 wherein the delivery device includes a spiral shaped body having revolution layers having a continuous outer edge that engages the side wall of the tubular frame when positioned within the tubular frame.

14. The plant irrigation, oxygenation, and feeding device for plant roots of claim 13 wherein the revolution layers include orifices formed therein allowing passage of water and air.

15. The plant irrigation, oxygenation, and feeding device for plant roots of claim 13 wherein the spiral shaped body includes a center void allowing passage of water and air.

16. The plant irrigation, oxygenation, and feeding device for plant roots of claim 13 further including an inner vertical surface formed on the spiral body separating the revolution layers forming a vertical column.

17. The plant irrigation, oxygenation, and feeding device for plant roots of claim 13 wherein the spiral shaped body includes a downward slope that centrifugally guides water to the outer edge of the delivery device and down the sidewall of the tubular frame.

18. The plant irrigation, oxygenation, and feeding device for plant roots of claim 1 wherein the at least one delivery device is positioned within the tubular frame of from 1 to 8 inches below a soil surface.

19. A plant irrigation, oxygenation, and feeding device comprising:
an elongated tubular frame having a sidewall and a cap positioned on each end, the sidewall including a plurality of apertures dimensioned to increase the surface area of the side wall while permitting the passage of air and water from the interior of the tubular frame to the exterior of the tubular frame; and
at least one delivery device positioned within the tubular frame the delivery device directing water to the sidewall, the delivery device including a series of openings formed therein allowing water to pass through the delivery device and convective air currents to travel within the tubular frame.

20. A plant irrigation, oxygenation, and feeding device comprising:
an elongated tubular frame having a sidewall and a cap positioned on each end, the sidewall including a plurality of apertures dimensioned to increase the surface area of the side wall while permitting the passage of air and water from the interior of the tubular frame to the exterior of the tubular frame; and
at least one delivery device positioned within the tubular frame the delivery device directing water to the sidewall, the delivery device including a body formed of flexible material, the body including a peripheral edge that engages the side wall of the tubular body when the delivery device is positioned in the tubular frame, the delivery device including slotted openings formed in the body, the slotted openings extending from the edge toward the center of the body wherein the slotted openings compress when the delivery device is positioned in the tubular frame such that the body moves forming a frustum or domed shaped delivery device that delivers water evenly down the side wall of the tubular frame wherein the water interlaces with the plurality of apertures delivering water gently to a surrounding soil and oxygenating the water.
